(19) United States
(12) Patent Application Publication
(10) Pub. No.: US 2009/0234854 A1
(43) Pub. Date: Sep. 17, 2009

(54) SEARCH SYSTEM AND SEARCH METHOD FOR SPEECH DATABASE

(75) Inventors: Naoyuki Kanda, Kokubunji (JP); Takashi Sumiyoshi, Kokubunji (JP); Yasunari Obuchi, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/270,147

(22) Filed: Nov. 13, 2008

(30) Foreign Application Priority Data
Mar. 11, 2008 (JP) 2008-60778

(51) Int. Cl. G06F 17/30; G10L 15/04

(52) U.S. Cl. 707/6; 704/251; 707/E17.001

(57) ABSTRACT

An acoustic feature representing speech data provided with meta data is extracted. Next, a group of acoustic features which are extracted only from the speech data containing a specific word in the meta data and not from the other speech data is extracted from obtained sub-groups of acoustic features. The word and the extracted group of acoustic features are associated with each other to be stored. When there is a search key matching the word in the input search keys, the group of acoustic features corresponding to the word is output. Accordingly, the efforts of a user for inputting a key when the user searches for speech data are reduced.

### CLAIM OF PRIORITY

The present application claims priority from Japanese application P2008-60778 filed on Mar. 11, 2008, the content of which is hereby incorporated by reference into this application.

### BACKGROUND OF THE INVENTION

This invention relates to a speech search device for allowing a user to detect a segment, in which a desired speech is uttered, based on a search keyword from speech data associated with a TV program or a camera image or from speech data recorded at a call center or for a meeting log, and to an interface for the speech search device.

With a recent increase in capacity of a storage device, a larger amount of speech data has been stored. In a large number of conventional speech databases, information of a time, at which a speech is recorded, is provided to manage speech data. Based on the thus provided time information, a search is performed for desired speech data. For the search based on the time information, however, it is necessary to know in advance the time at which the desired speech is uttered. Therefore, such a search is not suitable for searching for a speech containing a specific utterance. When the search is performed for the speech containing the specific utterance, it is necessary to listen to the speech from beginning to end.

Thus, a technology for detecting a position in the speech database, at which a specific keyword is uttered, is required. For example, the following technology is known. According to the technology, an association between an acoustic feature vector representing an acoustic feature of the keyword and an acoustic feature vector of the speech database is obtained in consideration of time warping to detect the position in the speech database, at which the keyword is uttered (Japanese Patent Application Laid-open No. Sho 55-2205 (hereinafter, referred to as Patent Document 1) and the like).

The following technology is also known. According to the technology, a speech pattern stored in a keyword candidate storage section is used as a keyword to search for the speech data without directly using the speech uttered by a user as the keyword (for example, Japanese Patent Application Laid-open No. 2001-290496 (hereinafter, referred to as Patent Document 2)).

As another known method, the following system has been realized. The system converts the speech data into a word lattice representation by a speech recognizer, and then, searches for the keyword on the generated word lattice to find the position on the speech database, at which the keyword is uttered, by the search.

In the speech search system for detecting the position at which the keyword is uttered as described above, the user inputs a word, which is likely to be uttered in a desired speech segment, to the system as a search keyword. For example, the user who wishes to “find a speech when Ichiro is interviewed” inputs “Ichiro, interview” as search keys for a speech search to detect the speech segment.

### SUMMARY OF THE INVENTION

In the speech search system for detecting the position at which the keyword is uttered as in the conventional examples, however, the keyword input by the user as the search key is not necessarily uttered in the speech segment desired by the user. In the above-mentioned example, it is conceived that the utterance “interview” never appears in the speech when “Ichiro is interviewed”. In such a case, even if the user inputs “Ichiro, interview” as the search keywords, the user cannot obtain the desired speech segment when “Ichiro is interviewed” by the system for detecting the segment in which “Ichiro” and “interview” are uttered.

In such a case, the user conventionally has no choice but to input a keyword which is likely to be uttered in the desired speech segment in a trial-and-error manner for the search. Therefore, much effort is required to find the desired speech segment by the search. In the above-mentioned example, the user just has to input words which are likely to be uttered when “Ichiro is interviewed” (for example, “comment is ready” , “good game”, and the like) in a trial-and-error manner for the search.

This invention has been devised in view of the above-mentioned problem, and has an object of displaying an acoustic feature corresponding to an input search keyword for a user to reduce the efforts for key input when the user searches for speech data.

According to this invention, a speech database search system comprising: a speech database for storing speech data; a search data generating module for generating search data for search from the speech data before performing a search for the speech data; and a searcher for searching for the search data based on a preset condition, wherein the speech database adds meta data for the speech data to the speech data and stores the meta data added to the speech data, and wherein the search data generating module includes: an acoustic feature extractor for extracting an acoustic feature for each utterance from the speech data; an association creating module for clustering the extracted acoustic features and then creating an association between the clustered acoustic features and a word contained in the meta data as the search data; and an association storage module for storing the associated search data.

Therefore, this invention displays the acoustic feature corresponding to the search key for a user when the search key is input, whereby the efforts for key input when the user searches for the speech data are reduced.

### BRIEF DESCRIPTION OF THE DRAWINGS

FIG. 1 for illustrating a first embodiment is a block diagram illustrating a configuration of a computer system to which this invention is applied.

FIG. 2 is a block diagram illustrating functional elements of the speech search application 10.

FIG. 3 is an explanatory view illustrating an example of the EPG information.

FIG. 4 is a block diagram illustrating the details of functional elements of the acoustic feature extractor 103.

FIG. 5 is a problem analysis diagram (PAD) illustrating an example of a procedure of processing for creating the associations between words and acoustic features, which is executed by the speech search application 10.

FIG. 6 is a PAD (structured flowchart) illustrating an example of a procedure of processing in the keyword input module 107, the speech searcher 108, the result display module 109, the acoustic feature search module 110, and the acoustic feature display module 111, which is executed by the speech search application 10.

FIG. 7 is an explanatory view illustrating the types of acoustic features and examples of the features.

FIG. 8 is an explanatory view illustrating an example of the created associations between words and acoustic features, and illustrates the associations between the words and the acoustic features.

FIG. 9 is a screen image illustrating the result of search for the keywords.

FIG. 10 is a screen image illustrating recommended keywords when no result is found by the search for the keyword.

FIG. 11 for illustrating the second embodiment is a block diagram of the computer system to which this invention is applied.

FIG. 12 for illustrating the second embodiment is an explanatory view illustrating an example of information for the speech data.

FIG. 13 for illustrating the second embodiment is an explanatory view illustrating the associations between the words in the meta data word sequence and the acoustic features.

FIG. 14 for illustrating the second embodiment is a screen image showing an example of the user interface provided by the keyword input module 107.

FIG. 15 for illustrating the second embodiment is a screen image showing the result of search for the search key.

FIG. 16 for illustrating the second embodiment is a screen image showing a recommended key when no result is found for the search key.

### DETAILED DESCRIPTION OF THE PREFERRED EMBODIMENTS

### First Embodiment

Hereinafter, an embodiment of this invention will be described based on the accompanying drawings.

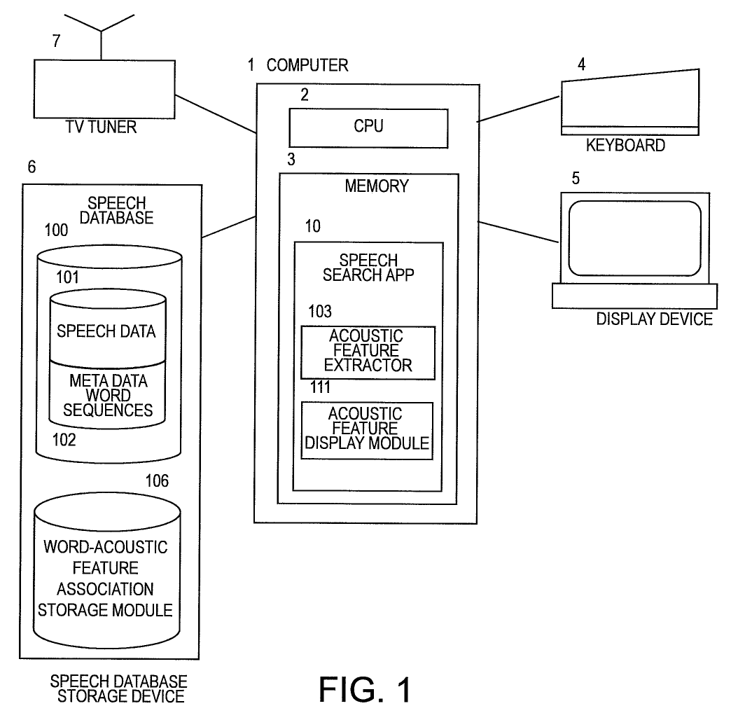

FIG. 1 for illustrating a first embodiment is a block diagram illustrating a configuration of a computer system to which this invention is applied.

As the computer system according to this first embodiment, an example where a speech search system for recording a video image and speech data of a television (TV) program and searching for a speech segment containing a search keyword designated by a user on the speech data is configured will be described. In FIG. 1, the computer system is comprised of a computer 1 including a memory 3 and a processor (CPU) 2. The memory 3 stores programs and data. The processor 2 executes the program stored in the memory 3 to perform computational processing. A TV tuner 7, a speech database storage device 6, a keyboard 4, and a display device 5 are connected to the computer 1. The TV tuner 7 receives TV broadcasting. The speech database storage device 6 records speech data and adjunct data of the received TV broadcasting. The keyboard 4 serves to input a search keyword or an instruction. The display device 5 displays the search keyword or the result of search. A speech search application 10 for receiving the search keyword from the keyboard 4 to search for a speech segment containing the search keyword from the speech data stored in the speech database storage device 6 is loaded into the memory 3 to be executed by the processor 2. As described below, the speech search application 10 includes an acoustic feature extractor 103 and an acoustic feature display module 111.

The speech database storage device 6 includes a speech database 100 for storing the speech data of the TV program received by the TV tuner 7. The speech database 100 stores speech data 101 contained in the TV broadcasting and the adjunct data contained in the TV broadcasting as a meta data word sequence 102, as described below. The speech database storage device 6 includes a word-acoustic feature association storage module 106 for storing an association between a word and acoustic features, which represents an association between acoustic features of the speech data 101 created by the speech search application 10 and the meta data word sequence 102, as described below.

The speech data 101 of the TV program received by the TV tuner 7 is written in the following manner. The speech data 101 and the meta data word sequence 102 are extracted by an application (not shown) on the computer 1 from the TV broadcasting, and then, are written in the speech database 100 of the speech database storage device 6.

Upon designation of a search keyword by a user using the keyboard 4, the speech search application 10 executed in the computer 1 detects a position (speech segment) at which the search keyword is uttered on the speech data 101 in the TV program stored in the speech database storage device 6, and displays the result of search for the user by the display device 5. In this first embodiment, for example, electronic program guide (EPG) information containing text data indicating the contents of the program is used as the adjunct data of the TV broadcasting.

The speech search application 10 extracts the search keyword from the EPG information stored in the speech database storage device 6 as the meta data word sequence 102, extracts the acoustic feature corresponding to the search keyword from the speech data 101, creates the association between the word and the acoustic features, which indicates the association between the acoustic feature of the speech data 101 and the meta data word sequence 102, and stores the created association in the word-acoustic feature association storage module 106. Then, upon reception of the keyword from the keyboard 4, the speech search application 10 displays the corresponding search keyword from the search keywords stored in the word-acoustic feature association storage module 106 to appropriately guide a search request of the user. The EPG information is used as the meta data in the following example. However, when more specific meta data information is associated with the program, the specific meta data information can also be used.

The speech database 100 treated in this first embodiment includes the speech data 101 extracted from a plurality of TV programs. To each piece of the speech data 101, the EPG information associated with the TV program, from which the speech data 101 is extracted, is adjunct as the meta data word sequence 102.

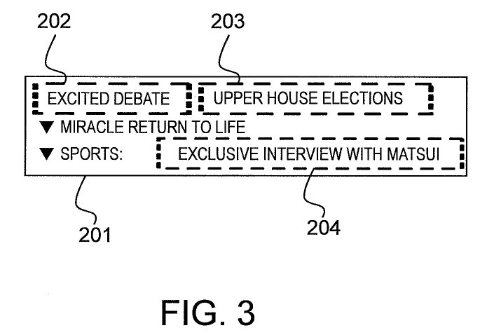

The EPG information 201 consists of a text such as a plurality of keywords or closed caption information, as illustrated in FIG. 3. FIG. 3 is an explanatory view illustrating an example of the EPG information. Character strings illustrated in FIG. 3 are converted into word sequences by the speech search application 10 using morphological analysis processing. As a result, “excited debate” 202, “Upper House elections” 203, “interview” 204, and the like are extracted as the meta data word sequence. Since a known method may be used for the morphological analysis processing performed in the speech search application 10, the detailed description thereof is herein omitted.

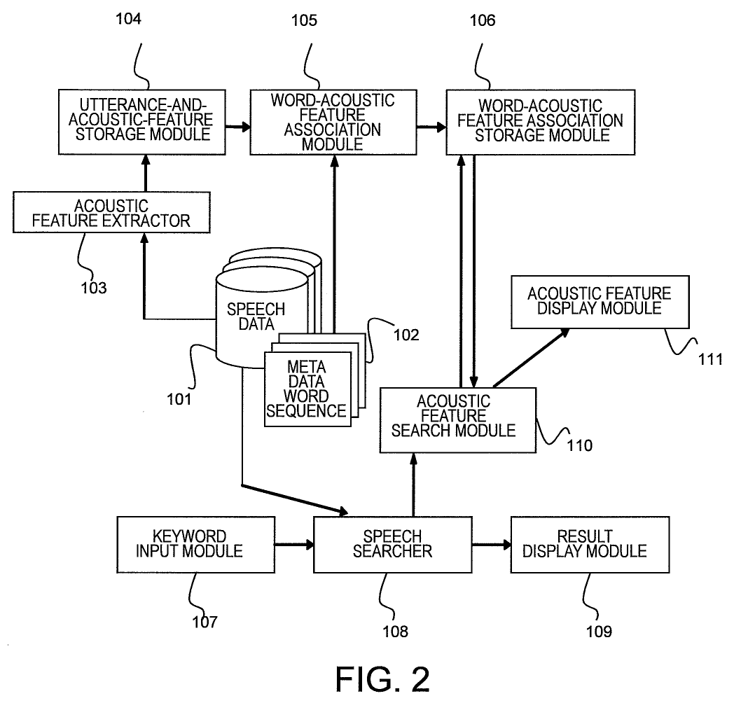

Next, FIG. 2 is a block diagram illustrating functional elements of the speech search application 10. The speech search application 10 creates the associations between words and acoustic features from the speech data 101 and the meta data word sequence 102 at predetermined timing (for example, at the completion of recording or the like) to store the created association in the word-acoustic feature association storage module 106 in the speech database storage device 6.

The functional elements of the speech search application 10 are roughly classified into blocks (103 to 106) for creating the associations between words and acoustic features and those (107 to 111) for searching for the speech data 101 by using the associations between words and acoustic features.

The blocks for creating the associations between words and acoustic features, include an acoustic feature extractor 103, an utterance-and-acoustic-feature storage module 104, a word-acoustic feature association module 105, and the word-acoustic feature association storage module 106. The acoustic feature extractor 103 splits the speech data 101 into utterance units to extract an acoustic feature of each of the utterances. The utterance-and-acoustic-feature storage module 104 stores the acoustic feature for each utterance unit. The word-acoustic feature association module 105 extracts a relation between the acoustic feature for each utterance and the meta data word sequence 102 of the EPG information. The word-acoustic feature association storage module 106 stores the extracted association between the meta data word sequence 102 and the acoustic feature.

The blocks for performing a search, include a keyword input module 107, a speech searcher 108, a result display module 109, an acoustic feature search module 110, and the acoustic feature display module 111. The keyword input module 107 provides an interface for receiving the search keyword (or the speech search request) input by the user from the keyboard 4. The speech searcher 108 detects the position at which the keyword input by the user is uttered on the speech data 101. The result display module 109 outputs the position, at which the keyword is uttered on the speech data 101, to the display device 5 when the position is successfully detected. The acoustic feature search module 110 searches for the meta data word sequence 102 and the acoustic feature, which correspond to the keyword, from the word-acoustic feature association storage module 106. The acoustic feature display module 111 outputs the meta data word sequence 102 and the acoustic feature, which correspond to the keyword, to the display device 5.

Hereinafter, each of the blocks of the speech search application 10 will be described.

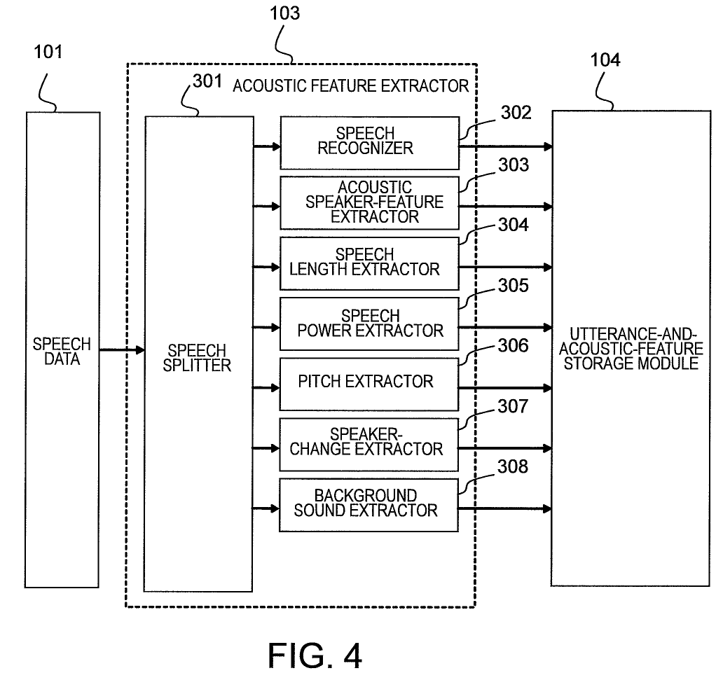

First, the acoustic feature extractor 103 for splitting the speech data 101 into the utterance units to extract the acoustic features of each utterance is configured as illustrated in FIG. 4. FIG. 4 is a block diagram illustrating the details of functional elements of the acoustic feature extractor 103.

In the acoustic feature extractor 103, a speech splitter 301 reads the designated speech data 101 from the speech database 100 to split the speech data into utterance units. Processing for splitting the speech data 101 into the utterance units can be realized by regarding the utterance being completed when a power of the speech is equal to or less than a given value within a given period of time.

Next, the acoustic feature extractor 103 extracts any of speech recognition result information, acoustic speaker-feature information, speech length information, pitch information, speaker-change information, speech power information, and background sound information, or the combination thereof as the acoustic feature for each utterance to store the extracted acoustic feature in the utterance-and-acoustic-feature storage module 104. Means for obtaining each piece of the above-mentioned information and a format of each feature will be described below.

The speech recognition result information is obtained by converting the speech data 101 into the word sequence by a speech recognizer 302. The speech recognition is reduced to a problem of maximizing a posteriori probability represented by the following formula when a speech waveform of the speech data 101 is X and a word sequence of the meta data word sequence 102 is W.

$${max}_{W} P ( W \vert X ) = {max}_{W} \frac{P ( X \vert W ) P ( W )}{P ( X )} = {max}_{W} P ( X \vert W ) P ( W ) \qquad [ Formula 1 ]$$

The above-mentioned formula is explored based on an acoustic model and a language model learned from a large amount of learning data. Since a known technology may be appropriately used as the method of speech recognition, the description thereof is herein omitted.

A frequency of presence of each word in the word sequence obtained by the speech recognizer 302 is used as the acoustic feature (speech recognition result information). In association with the word sequence obtained by the speech recognizer 302, a speech recognition score of the whole utterance or a confidence measure for each word may be extracted to be used. Further, the combination of a plurality of words such as “comment is ready” may also be used as the acoustic feature.

The acoustic speaker-feature information is obtained by an acoustic speaker-feature extractor 303. The acoustic speaker-feature extractor 303 records speeches of multiple (N) speakers in advance, and models the recorded speeches by the gaussian mixture model (GMM). Upon input of an utterance X, the acoustic speaker-feature extractor 303 obtains a probability P (X|GMMᵢ) of the generation of the utterance from each of the gaussian mixture models GMMI (i=1 to N) for each of the gaussian mixture models GMMI to obtain an N-dimensional feature. The acoustic speaker-feature extractor 303 outputs the obtained N-dimensional feature as the acoustic speaker-feature information of the utterance.

The speech length information is obtained by measuring a time length during which the utterance lasts, for each utterance. The utterance length can also be obtained as a ternary-value feature by classifying the utterances into a “short” utterance which is shorter than a certain value, a “long” utterance which is longer than the certain value, and a “normal” utterance other than those described above.

The pitch feature information is obtained in the following manner. After a fundamental frequency component of the speech is extracted by the pitch extractor 306, the extracted fundamental frequency component is classified into any of three values, specifically, that increasing, that decreasing, and that being flat at the ending of the utterance and is obtained as the feature. Since a known method may be used for the processing of extracting the fundamental frequency component, the detailed description thereof is herein omitted. It is also possible to represent a pitch feature of the utterance by a discrete parameter.

The speaker-change information is obtained by a speaker-change extractor 307. The speaker-change information is a feature representing whether or not an utterance preceding the utterance is made by the same speaker. Specifically, the speaker-change information is obtained in the following manner. If there is a difference equal to or larger than a predetermined threshold value in the N-dimensional feature representing the acoustic speaker-feature information between the utterance and the previous utterance, it is judged the speakers are different. If not, it is judged that the speakers are the same. Whether or not the speaker of the utterance and that of a subsequent utterance are the same can also be obtained by the same technology as that described above to be used as the feature. Further, information indicating the number of speakers present in a certain segment before and after the utterance can also be used as the feature.

The speech power information is represented as a ratio between the maximum power of the utterance and an average of the maximum power of the utterances contained in the speech data 101. It is apparent that an average power of the utterance and an average power of the utterances in the speech data may be compared with each other.

The background sound information is obtained by the background sound extractor 309. As the background sound, information indicating whether or not applause, a cheer, music, silence or the like is generated in the utterance or information indicating whether or not the above-mentioned sound is generated before or after the utterance is used. In order to judge the presence of the applause, the cheer, the music, the silence or the like, each of the sounds is first prepared and is then modeled with the gaussian mixture model GMM or the like. Upon input of the sound, a probability P (X|GMMᵢ) of the generation of the sound is obtained based on the gaussian mixture model GMM for each sound. When a value of the probability exceeds a given value, the background sound extractor 309 judges that the background sound is present. The background sound extractor 309 outputs information indicating the presence/absence for each of the applause, the cheer, the music, and the silence as a feature indicating the background sound information.

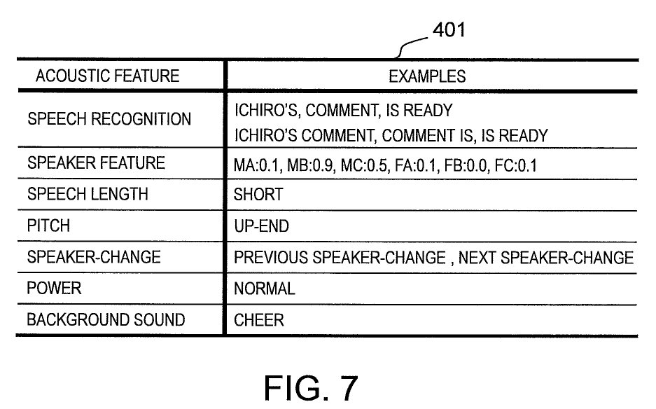

By performing the above-mentioned processing in the acoustic feature extractor 103, a set of the utterance and the acoustic features representing the utterance is obtained for the speech data 101 in the speech database 100. The features obtained in the acoustic feature extractor 103 are as illustrated in FIG. 7. FIG. 7 is an explanatory view illustrating the types of acoustic features and examples of the features. In FIG. 7, the type of an acoustic feature and an example 401 form a pair to be stored in the utterance-and-acoustic-feature storage module 104. It is apparent that the use of acoustic features which are not described above is also possible.

Next, the word-acoustic feature association module 105 illustrated in FIG. 2 extracts an association between the acoustic feature obtained by the acoustic feature extractor 103 and the word in the meta data word sequence 102 from which the EPG information is extracted.

In the following description, as an example of the meta data word sequence 102, attention is focused on a word arbitrarily selected by the word-acoustic feature association module 105 (hereinafter, referred to as a “marked word”). Then, the association between the marked word and the acoustic feature is extracted. Although a single word in the EPG information is selected as the marked word in this embodiment, a set of words in the EPG information may also be selected as the marked word.

In the word-acoustic feature association module 105, the acoustic features for each utterance, which are obtained by the acoustic feature extractor 103, are first clustered per utterance. The clustering can be performed by using a hierarchical clustering method. An example of the clustering processing performed in the word-acoustic feature association module 105 will be described below.

(i) Each of all the utterances is regarded as one cluster. The acoustic feature obtained from the utterance is regarded as the acoustic feature representing the utterance.

(ii) A distance between vectors of the acoustic features of the respective clusters is obtained. The clusters having the shortest distance among the vectors are merged. As the distance between the clusters, a cosine distance between the groups of the acoustic features, each representing the cluster, can be used. Moreover, if all the features are already converted into numerical values, the Mahalanobis distance or the like can also be used. The acoustic feature common to the two clusters before being merged is obtained as the acoustic feature representing the cluster obtained by the merge.

(iii) The above-mentioned processing (ii) is repeated. When all the distances between the clusters become a given value (predetermined value) or larger, the merge is terminated.

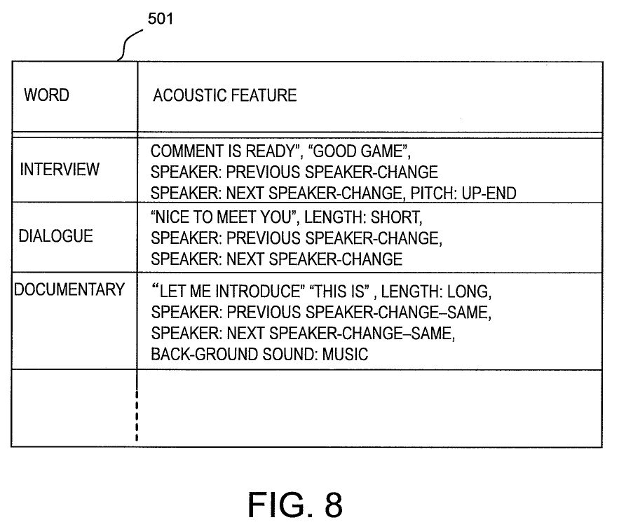

Next, the word-acoustic feature association module 105 extracts the cluster formed uniquely of a “speech utterance containing the marked word in the EPG information” from the clusters obtained by the above-mentioned operation. The word-acoustic feature association module 105 generates information of the association between the marked word and the group of acoustic features representing the extracted cluster as an association between the word and the acoustic features, and stores the created association in the word-acoustic feature association storage module 106. The word-acoustic feature association module 105 performs the above-mentioned processing for each of the words in the meta data word sequence 102 (EPG information) of the target speech data 101, regarding each of the words as the marked word, thereby creating the associations between words and acoustic features. At this time, data of the associations between words and acoustic features is stored in the word-acoustic feature association storage module 106 as illustrated in FIG. 8.

FIG. 8 is an explanatory view illustrating an example of the created associations between words and acoustic features, and illustrates the associations between the words and the acoustic features. In FIG. 8, the acoustic features corresponding to the word in the meta data word sequence 102 are stored as an association between a word and acoustic features 501. The acoustic feature includes any one of the speech recognition result information, the acoustic speaker-feature information, the speech length information, the pitch information, the speaker-change information, the speech power information, and the background sound information as described above.

Although the example where the above-mentioned processing is performed for all the words in the meta data word sequence 102 in the speech data 101 to be a target has been described above, the above-mentioned processing may be performed for only a part of the words in the meta data word sequence 102.

By the above-mentioned processing, the speech search application 10 creates the associations between the acoustic features for the respective utterances, which are extracted from the speech data 101 in the speech database 100, and the words contained in the EPG information of the meta data word sequence 102, as the associations between words and acoustic features 501, and stores the created associations in the word-acoustic feature association storage module 106. The speech search application 10 performs the above-mentioned processing as pre-processing preceding the use of the speech search system.

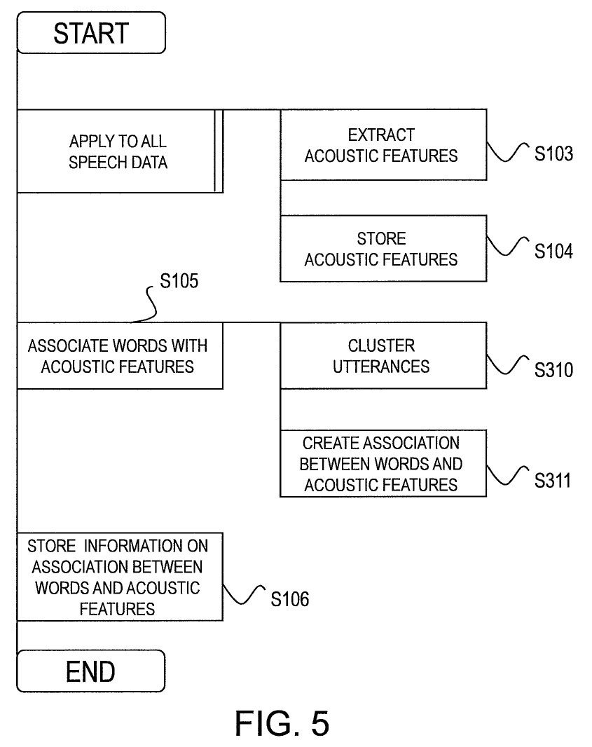

FIG. 5 is a problem analysis diagram (PAD) illustrating an example of a procedure of processing for creating the associations between words and acoustic features, which is executed by the speech search application 10. This processing is executed at predetermined timing (upon completion of recording of the speech data or upon instruction of the user).

First, in Step S103, the acoustic feature extractor 103 reads the speech data 101 designated by the speech splitter 301 illustrated in FIG. 4 from the speech database 100, and splits the read speech data 101 into utterance units. Then, the acoustic feature extractor 103 extracts any one of the speech recognition result information, the acoustic speaker-feature information, the speech length information, the pitch information, the speaker-change information, the speech power information, and the background sound information, or the combination thereof as the acoustic feature for each utterance. Next, in Step S104, the acoustic feature extractor 103 stores the extracted acoustic feature for each utterance in the utterance-and-acoustic-feature storage module 104.

Next, in Step S105, the word-acoustic feature association module 105 extracts the association between the acoustic feature for each utterance, which is stored in the utterance-and-acoustic-feature storage module 104, and the word in the meta data word sequence 102 from which the EPG information is extracted. The processing in Step S105 is the processing described above for the word-acoustic feature association module 105, and includes processing for hierarchically clustering the acoustic features for each utterance in the utterance unit (Step S310) and processing for generating information obtained by associating the marked word in the meta data word sequence 102 described above and the group of the acoustic features representing the cluster as the association between the word and the acoustic features (Step S311). Then, the speech search application 10 stores the created association between the word and the acoustic features in the word-acoustic feature association storage module 106.

By the above-mentioned processing, the speech search application 10 associates the information of the word to be searched with the acoustic feature, for each piece of the speech data 101.

Now, processing of the speech search application 10, which is performed when the user inputs the search keyword, will be described below.

The keyword input module 107 receives the keyword input by the user from the keyboard 4 and the speech data 101 corresponding to a search target, and proceeds with the processing as follows. Besides text data input from the keyboard 4, a speech recognizer may be used as the keyword input module 107 used in this processing.

First, the speech searcher 108 acquires the keyword input by the user and the speech data 101 from the keyword input module 107 to read the designated speech data 101 from the speech database 100. Then, the speech searcher 108 detects the position (utterance position) at which the keyword input by the user is uttered on the speech data 101. When a plurality of keywords are input to the keyword input module 107, the speech searcher 108 detects a segment corresponding to a time range containing the utterances of the keywords, which is smaller than a time range predefined on a temporal axis, as the utterance position. The detection of the utterance position of the keyword can be performed by using a known method, for example, described in Patent Document 1 cited above.

The utterance-and-acoustic-feature storage module 104 stores the words obtained by the speech recognition for each utterance as speech recognition features. The speech searcher 108 may obtain the utterance containing the speech recognition result, which matches the keyword, as the result of search.

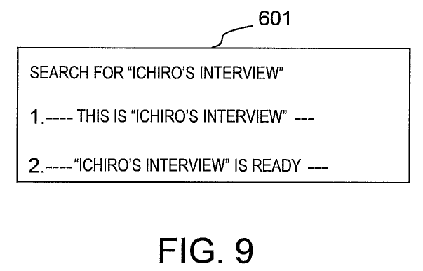

When the position, at which the keyword input by the user is uttered, is detected from the speech data 101 in the speech searcher 108, the utterance position is output by the result display module 109 to the display device 5 to be displayed for the user. As the contents output by the result display module 109 to the display device 5, the keywords input by the user, “Ichiro, interview” and the utterance positions found by the search are displayed as illustrated in FIG. 9. FIG. 9 is a screen image illustrating the result of search for the keywords. In this example, the case where the speech recognition result corresponding to the speech recognition feature of the speech segment containing the utterance position is displayed is illustrated.

On the other hand, when the speech searcher 108 does not successfully detect the position, at which the keyword designated by the user is uttered, on the speech data 101, the acoustic feature search module 110 searches the word-acoustic feature association storage module 106 for each keyword. If the keyword input by the user has been registered as the association between the word and the acoustic features, the association is extracted.

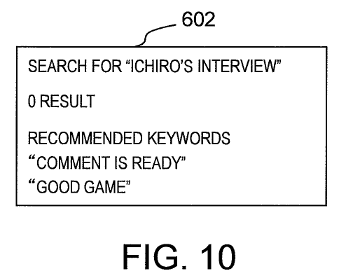

Here, when the acoustic feature search module 110 detects the acoustic feature (speech recognition result information, acoustic speaker-feature information, speech length information, pitch information, speaker-change information, speech power information, or background sound information) corresponding to the keyword designated by the user from the word-acoustic feature association storage module 106, the acoustic feature display module 111 displays the detected acoustic features as recommended search keywords for the user. For example, when word pairs “comment is ready” and “good game” are contained as the acoustic features for the word “interview”, the acoustic feature display module 111 displays the word pairs on the display device 5 for the user as illustrated in FIG. 10.

FIG. 10 is a screen image illustrating recommended keywords when no result is found by the search for the keyword. When the acoustic feature corresponding to the keyword is to be displayed, it is more preferable to perform a search for the speech data based on each acoustic feature to preferentially display the acoustic feature having a higher probability of the presence in the speech database 100 for the user.

The user can add the search keyword based on the information displayed on the display device 5 by the acoustic feature display module 111 to be able to efficiently search for the speech data.

The acoustic feature display module 111 includes an interface which allows the user to easily designate each of the acoustic features. It is more preferable that, when the user designates a certain acoustic feature, the designated acoustic feature be included in the search request.

Moreover, even when the speech data 101 satisfying the search request of the user is extracted, the acoustic feature display module 111 may display the acoustic feature corresponding to the search keyword input by the user.

Moreover, if an edit module for words and acoustic features, for editing the sets of words and acoustic features as illustrated in FIG. 8 is provided to the speech search application 10, the user can register the sets of words and acoustic features, which are frequently searched by the user. As a result, the operability can be improved.

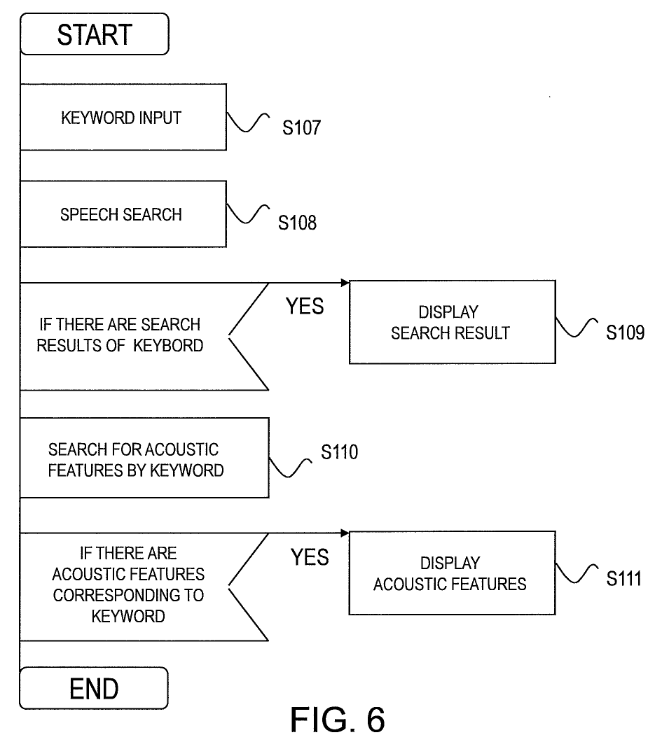

FIG. 6 is a PAD (structured flowchart) illustrating an example of a procedure of processing in the keyword input module 107, the speech searcher 108, the result display module 109, the acoustic feature search module 110, and the acoustic feature display module 111, which is executed by the speech search application 10.

First, in Step S107, the speech search application 10 receives the keyword input from the keyboard 4 and the speech data 101 corresponding to the search target.

Next, in Step S108, the speech search application 10 detects the position on the speech data 101, at which the keyword input by the user is uttered (utterance position), by the speech searcher 108 described above.

When the position, at which the keyword input by the user is uttered, is detected from the speech data 101, the speech search application 10 outputs the utterance position by the result display module 109 to the display device 5 to display the utterance position for the user in Step S109.

On the other hand, in Step S110, when the speech search application 10 does not successfully detect the position on the speech data 101, at which the keyword designated by the user is uttered, the acoustic feature search module 110 described above searches the word-acoustic feature association storage module 106 for each keyword to scan whether or not the keyword input by the user is registered as the associations between words and acoustic features.

When the speech search application 10 detects the acoustic feature (speech recognition result) corresponding to the keyword designated by the user from the word-acoustic feature association storage module 106 with the acoustic feature search module 110, the processing proceeds to Step S111 where the acoustic feature detected by the acoustic feature display module 111 described above is displayed as the recommended search keyword for the user.

By the above-mentioned processing, in response to the search keyword input by the user, the word contained in the EPG information of the meta data word sequence 102 can be displayed as the recommended keyword for the user.

As described above, in this invention, the plurality of pieces of the speech data 101, each being provided with the meta data word sequence 102, are stored in the speech database 100. The speech search application 10 extracts the speech recognition result information, the acoustic speaker-feature information, the speech length information, the pitch feature information, the speaker-change information, the speech power information, the background sound information or the like as the acoustic feature representing the speech data 101. Then, the speech search application 10 extracts the group of acoustic features which are extracted only from the speech data 101 including a specific word in the meta data word sequence 102 and not from the other speech data 101, from among the obtained sub-groups of acoustic features. Then, the speech search application 10 associates the specific word with the extracted group of acoustic features to obtain the association between the word and the acoustic features, and stores the obtained association between the word and the acoustic features. The extraction of the group of acoustic features for the specific word described above is performed for all the words in the meta data. The combinations of the words and the groups of acoustic features are obtained as the associations between words and acoustic features, which are stored in the word-acoustic feature association storage module 106. When there is any word which matches the word obtained by the association between the word and the acoustic features in the search keywords input by the user, the group of acoustic features corresponding to the word is displayed for the user.

In the speech search system for detecting the position at which the search keyword is uttered, the keyword input by the user as the search key is not necessarily uttered in a speech segment desired by the user. By using this invention, it is no longer necessary to input the search keyword in a trial-and-error manner. The use of the group of acoustic features corresponding to the word displayed on the display device 5 can greatly reduce the efforts needed for the search of the speech data.

### Second Embodiment

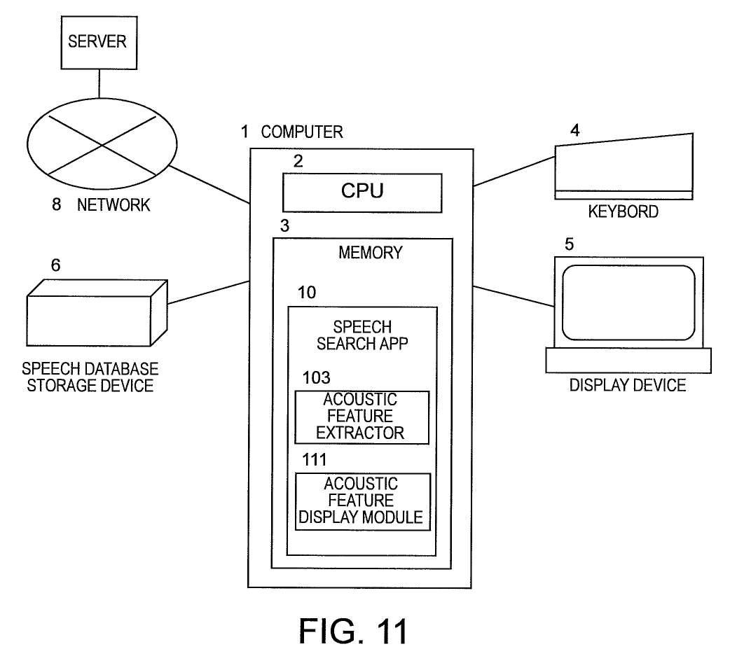

In the first embodiment described above, the keyword is input as the search key, and the acoustic feature display module 111 displays the feature of the speech recognition result on the display device 5. On the other hand, the following speech search system will be described in a second embodiment. In the speech search system according to the second embodiment, in addition to the keyword, any one of the acoustic speaker-feature information, the speech length information, the pitch feature information, the speaker-change information, the speech power information, and the background sound information is input as the search key. The speech search system searches for the acoustic feature based on the search key. FIG. 11 for illustrating the second embodiment is a block diagram of the computer system to which this invention is applied.

As the speech search system of this second embodiment, an example where the speech data 101 is acquired from a server 9 connected to the computer 1 through a network 8 in place of the TV tuner 7 illustrated in FIG. 1 of the first embodiment described above will be described as illustrated in FIG. 11. The computer 1 acquires the speech data 101 from the server 9 based on an instruction of the user to store the acquired speech data 101 in the speech database storage device 6.

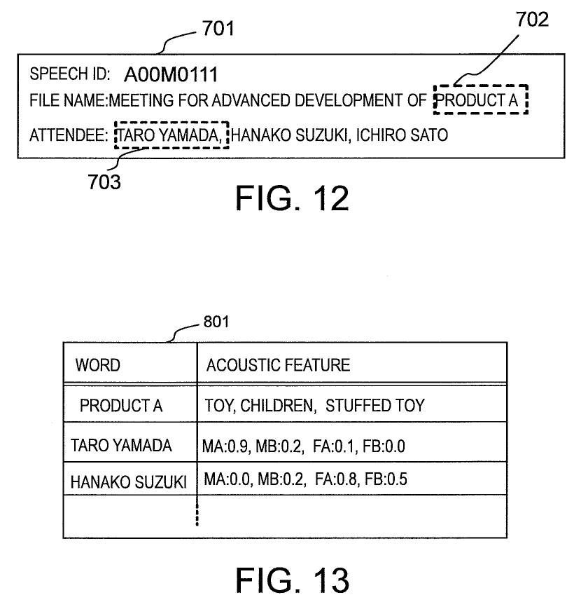

In this second embodiment, a speech in a meeting log is used as the speech data 101. FIG. 12 for illustrating the second embodiment is an explanatory view illustrating an example of information for the speech data. Each speech in the meeting log is provided with a file name 702, an attendee name 703, and a speech ID 701, as illustrated in FIG. 12. The morphological analysis processing performed on the speech data 101 allows the extraction of words such as “product A” 702 and “Taro Yamada” 703. Hereinafter, an example where the words extracted from the speech data 101 by the morphological analysis processing are used as the meta data word sequence 102 will be described. The following manner is also possible to extract the meta data word sequence 102. The file name or the attendee name is uttered when the speech in the meeting is recorded for the meeting log. The utterance is converted into a word sequence by the speech recognition processing described in the first embodiment to extract the file name 702 or the attendee name 703. Then, the meta data word sequence 102 is extracted by the same processing as that described above.

Before the user inputs the search key information, the acoustic feature extractor 103 extracts any one of the speech recognition result information, the acoustic speaker-feature information, the speech length information, the pitch information, the speaker-change information, the speech power information, and the background sound information, or the combination thereof as the acoustic feature for each utterance from the speech data 101, as in the first embodiment. Further, the word-acoustic feature association module 105 extracts the association between the acoustic feature obtained in the acoustic feature extractor 103 and the word in the meta data word sequence 102 to store the obtained association in the word-acoustic feature association storage module 106. Since the details of the processing are the same as those described above in the first embodiment, the overlapping description is herein omitted.

As a result, the association between the word in the meta data word sequence 102 and the acoustic feature is obtained as illustrated in FIG. 13 to be stored in the word-acoustic feature association storage module 106. FIG. 13 for illustrating the second embodiment is an explanatory view illustrating the associations between the words in the meta data word sequence and the acoustic features.

In this second embodiment, in addition to the associations between words and acoustic features, the set of the utterance and the acoustic feature described above is stored in the utterance-and-acoustic-feature storage module 104.

The processing described above is terminated before the user inputs the search key. Hereinafter, processing of the speech search application 10 when the user inputs the search key will be described.

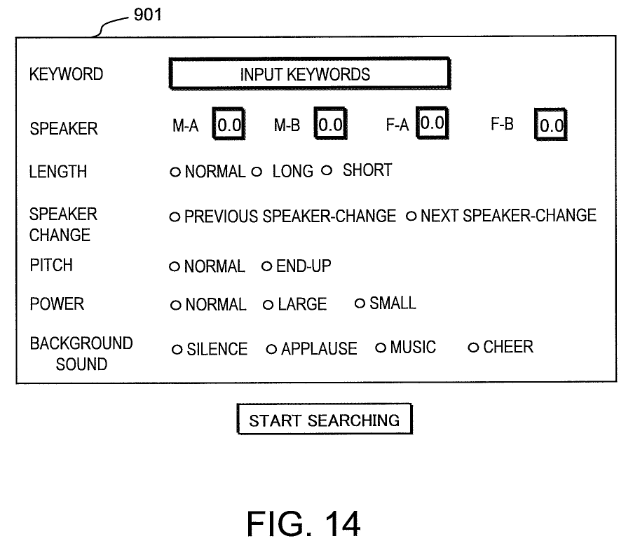

The user can input any one of the acoustic speaker-feature information, the speech length information, the pitch feature information, the speaker-change information, the speech power information, and the background sound information as the search key in addition to the keyword. Therefore, the keyword input module 107 includes, for example, an interface as illustrated in FIG. 14. FIG. 14 for illustrating the second embodiment is a screen image showing an example of the user interface provided by the keyword input module 107.

When the user inputs the search key through the user interface illustrated in FIG. 14, the speech search application 10 detects a speech segment which provides the best match for the search key with the speech searcher 108. For the detection of the speech segment, it is sufficient to search for the utterance having the acoustic feature stored in the utterance-and-acoustic-feature storage module 104, which matches the search key.

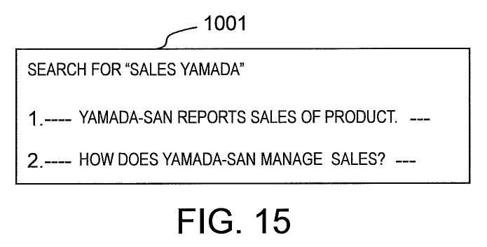

When the utterance matching the search key is detected, the speech search application 10 displays an output as illustrated in FIG. 15 using the utterance as the result of search on the display device 5 for the user. FIG. 15 for illustrating the second embodiment is a screen image showing the result of search for the search key.

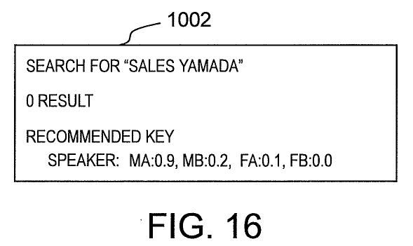

On the other hand, when the utterance matching the search key is not detected and the word is contained in the search key, the speech search application 10 searches the word-acoustic feature association storage module 106 to search for the acoustic feature corresponding to the word in the search key. When the acoustic feature matching the input search key is found by the search, the found acoustic feature is output to the display device 5 to be displayed for the user as illustrated in FIG. 16. FIG. 16 for illustrating the second embodiment is a screen image showing a recommended key when no result is found for the search key.

In the manner as described above, the user designates the acoustic feature as illustrated in FIG. 16, which is displayed by the speech search system on the display device 5, to be able to search for a desired speech segment. As a result, it is possible to spare the efforts of inputting the search key in a trial-and-error manner as in the conventional examples.

As described above, this invention is applicable to the speech search system for searching for the speech data, and further to a device for recording the contents, a meeting system using the speech data, and the like.

While the present invention has been described in detail and pictorially in the accompanying drawings, the present invention is not limited to such detail but covers various obvious modifications and equivalent arrangements, which fall within the purview of the appended claims.

What is claimed is:

1. A speech database search system comprising:
a speech database for storing speech data;
a search data generating module for generating search data for search from the speech data before performing a search for the speech data; and
a searcher for searching for the search data based on a preset condition,
wherein the speech database adds meta data for the speech data to the speech data and stores the meta data added to the speech data, and
wherein the search data generating module includes:
an acoustic feature extractor for extracting an acoustic feature for each utterance from the speech data;
an association creating module for clustering the extracted acoustic features and then creating an association between the clustered acoustic features and a word contained in the meta data as the search data; and
an association storage module for storing the associated search data.

2. The speech database search system according to claim 1, wherein the searcher includes:
a search key input module for inputting a search key for searching the speech database as the preset condition;
a speech data searcher for detecting an utterance position at which the search key matches with the search data in the speech data;
an acoustic feature search module for searching for the acoustic feature corresponding to the search key from the search data; and
a display module for outputting a search result obtained by the speech data searcher and a search result obtained by the acoustic feature search module.

3. The speech database search system according to claim 1, wherein the acoustic feature extractor includes:
a speech splitter for splitting the speech data into each utterance;
a speech recognizer for performing speech recognition on the speech data for each utterance to output a word sequence as speech recognition result information;
an acoustic speaker-feature extractor for comparing a preset speech model and the speech data with each other to extract a feature of a speaker for each utterance, which is contained in the speech data, as acoustic speaker-feature information;
a speech length extractor for extracting a length of the utterance contained in the speech data as speech length information;
a pitch extractor for extracting a pitch for each utterance contained in the speech data as pitch information;
a speaker-change extractor for extracting speaker-change information as a feature indicating whether or not the utterances in the speech data are made by the same speaker from the speech data;
a speech power extractor for extracting a power for each utterance contained in the speech data as speech power information; and
a background sound extractor for extracting a background sound contained in the speech data as background sound information, and
wherein at least one of the speech recognition result information, the acoustic speaker-feature information, the speech length information, the pitch information, the speaker-change information, the speech power information, and the background sound information is output.

4. The speech database search system according to claim 2, wherein the display module includes an acoustic feature display module for outputting the acoustic feature searched by the acoustic feature search module.

5. The speech database search system according to claim 4, wherein the acoustic feature display module preferentially outputs the acoustic feature having a high probability of presence in the speech data among the acoustic features searched by the acoustic feature search module.

6. The speech database search system according to claim 5, further comprising a speech data designating module for designating the speech data as a search target,
wherein the acoustic feature display module preferentially outputs the acoustic feature having the high probability of the presence in the speech data designated as the search target among the acoustic features searched by the acoustic feature search module.

7. The speech database search system according to claim 1, wherein the search data generating module includes an edit module for words and acoustic features, for adding, deleting, and editing a set of the acoustic features.

8. The speech database search system according to claim 3, wherein the searcher includes a search key input module for inputting a search key for searching the speech database, and
wherein the search key input module receives a keyword and at least one of the acoustic speaker-feature information, the speech length information, the pitch information, the speaker-change information, the speech power information, and the background sound information.

9. A speech database search method, causing a computer to search for speech data stored in a speech database under a preset condition, comprising:
generating, by the computer, search data for search from the speech data before performing a search for the speech data; and
searching, by the computer, for the search data based on the preset condition,
wherein the speech database adds meta data for the speech data to the speech data and stores the meta data added to the speech data, and
wherein the generating, by the computer, the search data for search from the speech data, includes:
extracting an acoustic feature for each utterance from the speech data;
clustering the extracted acoustic features and then creating an association between the clustered acoustic features and a word contained in the meta data as the search data; and
storing the associated search data.

10. The speech database search method according to claim 9, wherein the searching, by the computer, for the search data based on the preset condition, comprising the steps of:
inputting a search key for searching the speech database as the preset condition;
detecting an utterance position at which the search key matches with the search data in the speech data;
searching for an acoustic feature corresponding to the search key from the search data; and
outputting a search result for the speech data and a search result for the acoustic feature.

11. The speech database search method according to claim 9, wherein the extracting the acoustic feature, comprising the steps of:
splitting the speech data into each utterance;
performing speech recognition on the speech data for each utterance to output a word sequence as speech recognition result information;
comparing a preset speech model and the speech data with each other to extract a feature of a speaker for each utterance, which is contained in the speech data, as acoustic speaker-feature information;
extracting a length of the utterance contained in the speech data as speech length information;
extracting a pitch for each utterance contained in the speech data as pitch information;
extracting speaker-change information as a feature indicating whether or not the utterances in the speech data are made by the same speaker from the speech data;
extracting a power for each utterance contained in the speech data as speech power information; and
extracting a background sound contained in the speech data as background sound information, and
wherein at least one of the speech recognition result information, the acoustic speaker-feature information, the speech length information, the pitch information, the speaker-change information, the speech power information, and the background sound information is output.

12. The speech database search method according to claim 10, wherein the searched acoustic feature is output in the step of outputting the search result for the speech data and the search result for the acoustic feature.

13. The speech database search method according to claim 12, wherein the acoustic feature having a high probability of presence in the speech data among the searched acoustic features is preferentially output in the step of outputting the search result for the speech data and the search result for the acoustic feature.

14. The speech database search method according to claim 13, further comprising the step of:
designating the speech data as a search target;
wherein the acoustic feature having the high probability of presence in the speech data designated as the search target among the searched acoustic features is preferentially output in the step of outputting the search result for the speech data and the search result for the acoustic feature.

15. The speech database search method according to claim 9, further comprising the steps of adding, deleting, and editing a set of the acoustic features.

16. The speech database search method according to claim 11, wherein the searching, by the computer, for the search data based on the preset condition comprising the step of:
inputting a search key for searching the speech database;
wherein, in the step of inputting the search key, a keyword and at least one of the acoustic speaker-feature information, the speech length information, the pitch information, the speaker-change information, the speech power information, and the background sound information are received.
